(19) United States
(12) Patent Application Publication
(10) Pub. No.: US 2025/0300531 A1
(43) Pub. Date: Sep. 25, 2025

(54) IRON CORE ANNEALING METHOD

(71) Applicant: TOYOTA BOSHOKU KABUSHIKI KAISHA, Aichi-ken (JP)

(72) Inventor: Masaki SUGIYAMA, Okazaki-shi (JP)

(73) Assignee: TOYOTA BOSHOKU KABUSHIKI KAISHA, Aichi-ken (JP)

(21) Appl. No.: 19/068,121

(22) Filed: Mar. 3, 2025

(30) Foreign Application Priority Data
Mar. 21, 2024 (JP) 2024-045337

(51) Int. Cl. H02K 15/0275

(52) U.S. Cl. CPC H02K 15/0275

(57) ABSTRACT

A method of annealing an iron core includes placing the iron core on a placement surface of an annealing jig formed of a material having a coefficient of linear expansion different from that of a material of the iron core, and annealing the iron core placed on the placement surface. Multiple protrusions that support the iron core from below and are spaced apart from each other are formed on the placement surface.

### CROSS-REFERENCE TO RELATED APPLICATIONS

This application is based upon and claims the benefit of priority from Japanese Patent Application No. 2024-045337, filed on Mar. 21, 2024, the entire contents of which are incorporated herein by reference.

### BACKGROUND

### 1. Field

The present disclosure relates to a method of annealing an iron core and an annealing jig.

### 2. Description of Related Art

Conventionally, a motor core of a rotating electric machine is formed by a laminated iron core, in which multiple plate-shaped iron core pieces are stacked. These iron core pieces are formed by punching a steel sheet, which may induce residual stress, causing distortion in the iron core pieces. As a method of eliminating such distortion, annealing the laminated iron core in an atmosphere gas environment is known.

Japanese Laid-Open Patent Publication No. 2021-132434 discloses a method in which a laminated iron core placed on a plate-shaped pallet is annealed in an annealing furnace.

In the method described in the above publication, if the coefficients of linear expansion of the laminated iron core and the pallet are different from each other, the amounts of thermal expansion of the laminated iron core and the pallet are different from each other, and the amounts of thermal contraction of the laminated iron core and the pallet are different from each other. Therefore, during annealing of the laminated iron core, the laminated iron core and the pallet move relative to each other, resulting in sliding between the laminated iron core and the pallet. As a result, since a shearing force acts on the laminated iron core, the laminated iron core may be deformed and the dimensional accuracy of the laminated iron core may be reduced.

This issue is not limited to the annealing of laminated iron cores used in rotating electric machines but may similarly occur during the annealing of various types of iron cores that utilize the principle of electromagnetic induction.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, a method of annealing an iron core includes: placing the iron core on a placement surface of an annealing jig formed of a material having a coefficient of linear expansion different from that of a material of the iron core; and annealing the iron core placed on the placement surface. Multiple protrusions that support the iron core from below and are spaced apart from each other are formed on the placement surface.

In a second general aspect, a method of annealing an iron core includes: placing the iron core on a placement surface of an annealing jig formed of a material having a coefficient of linear expansion different from that of a material of the iron core; and annealing the iron core placed on the placement surface. The annealing jig includes a base and a coating film that covers a surface of the base and forms the placement surface. A coefficient of friction between the coating film and the iron core is smaller than a coefficient of friction between the base and the iron core.

In a third general aspect, an annealing jig includes a placement surface on which an iron core is placed when the iron core is annealed. The annealing jig is formed of a material having a coefficient of linear expansion different from that of a material of the iron core. Multiple protrusions are formed on the placement surface. The protrusions are configured to support the iron core from below and spaced apart from each other.

In a fourth general aspect, an annealing jig includes a placement surface on which an iron core is placed when the iron core is annealed. The annealing jig is formed of a material having a coefficient of linear expansion different from that of a material of the iron core. The annealing jig includes a base and a coating film that covers a surface of the base and forms the placement surface. A coefficient of friction between the coating film and the iron core is smaller than a coefficient of friction between the base and the iron core.

Other features and aspects will be apparent from the following detailed description, the drawings, and the claims.

### BRIEF DESCRIPTION OF THE DRAWINGS

FIG. 1 is a perspective view of a stator core according to a first embodiment.

FIG. 2 is a cross-sectional view of press-fit portions of the stator core shown in FIG. 1.

FIG. 3 is a cross-sectional view of an annealing jig according to the first embodiment.

FIG. 4 is a plan view of the annealing jig shown in FIG. 3.

FIG. 5 is a cross-sectional view of the stator core during annealing.

FIG. 6 is a cross-sectional view of an annealing jig according to a second embodiment.

FIG. 7 is a cross-sectional view of an annealing jig according to a third embodiment.

FIG. 8 is a plan view of an annealing jig according to a fourth embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

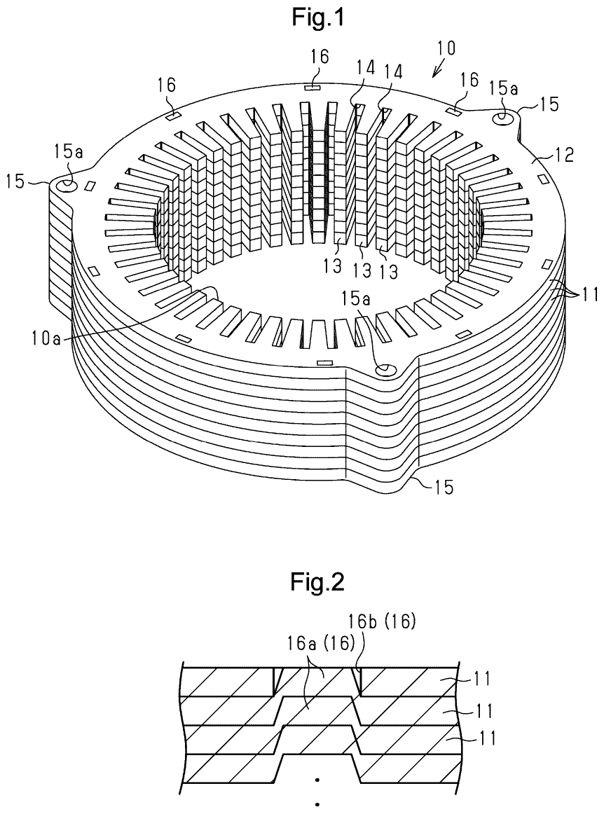

A method of annealing an iron core and an annealing jig according to a first embodiment will now be described with reference to FIGS. 1 to 5. The method of annealing an iron core and an annealing jig are used as a method of annealing a stator core 10 of a rotating electric machine and an annealing jig 20 used in the method. For illustrative purposes, some parts of the structures in the drawings may be exaggerated or simplified.

First, the stator core 10 will be described.

### Stator Core 10

As shown in FIG. 1, the stator core 10 has a substantially tubular shape with a center hole 10a. The stator core 10 is formed by stacking multiple thin plate-shaped iron core pieces 11. The iron core pieces 11 are each formed, for example, by punching an iron-based magnetic material such as a magnetic steel sheet. The stator core 10 is an example of an “iron core” and a “laminated iron core”.

In the following description, the stacking direction of the stator core 10 will simply be referred to as a stacking direction, a circumferential direction of the stator core 10 will simply be referred to as a circumferential direction, and a radial direction of the stator core 10 will simply be referred to as a radial direction.

The stator core 10 includes an annular yoke 12 and multiple teeth 13. The teeth 13 extend radially inward from the yoke 12 and are formed at intervals in the circumferential direction.

A slot 14 that opens inward in the radial direction and extends in the radial direction is formed between any two of the teeth 13 adjacent to each other in the circumferential direction.

The stator core 10 includes multiple mounting portions 15 for securing the stator core 10 to a case (not shown) of a rotating electric machine. The mounting portions 15 protrude radially outward from the outer peripheral portion of the yoke 12, and are provided at intervals in the circumferential direction. The stator core 10 of the present embodiment has three mounting portions 15. Each mounting portion 15 includes a mounting hole 15a that extends through the mounting portion 15 in the stacking direction. The stator core 10 is secured to the case by bolts (not shown) inserted into the respective mounting holes 15a.

The stator core 10 includes multiple press-fit portions 16 provided in the yoke 12 at intervals in the circumferential direction. The stator core 10 is formed by stacking multiple core blocks in which multiple iron core pieces 11 are secured to each other via the press-fit portions 16. The core blocks are joined to each other through welding, for example.

As shown in FIG. 2, the press-fit portions 16 each include tabs 16a formed in specified ones of the iron core pieces 11 and a through-hole 16b formed in one of the iron core pieces 11 different from the iron core pieces 11 in which the tabs 16a are formed. Each tab 16a bulges to one side in the stacking direction of the iron core pieces 11. The iron core pieces 11 with the tabs 16a are joined together through an interlocking engagement between the tabs 16a. One of the iron core pieces 11 with the tabs 16a is joined to the iron core piece 11 with the through-holes 16b by inserting the tabs 16a into the through-holes 16b, thereby securing them together.

### Annealing Jig 20

Next, the annealing jig 20 used for annealing the stator core 10 will be described.

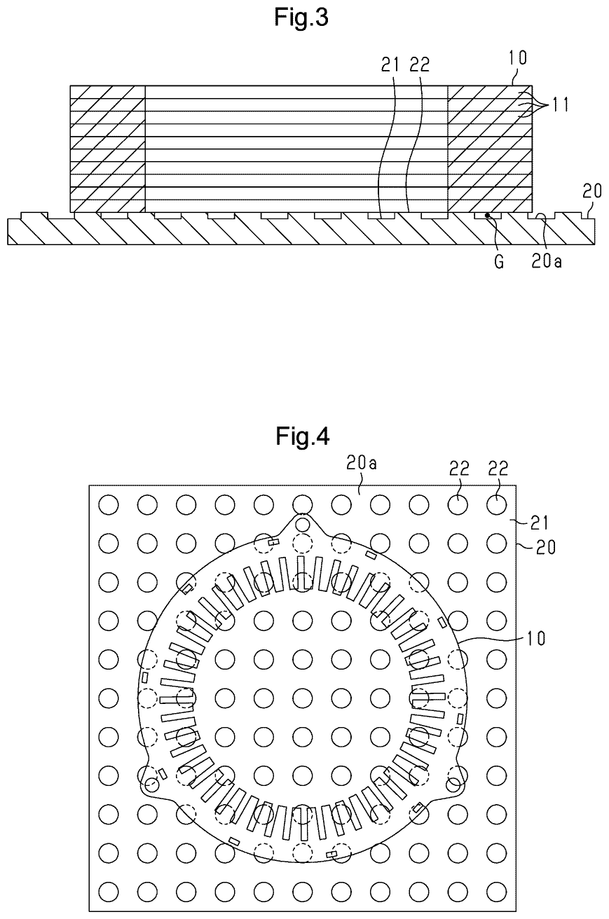

As shown in FIGS. 3 and 4, the annealing jig 20 is a jig on which the stator core 10 is placed when the stator core 10 is annealed. The annealing jig 20 also acts as a conveying jig for conveying the stator core 10 to an annealing furnace 40, which will be discussed below.

The annealing jig 20 has the shape of a flat plate. The annealing jig 20 is formed of a material having a coefficient of linear expansion different from that of a material of the stator core 10. The annealing jig 20 is made of, for example, stainless steel.

The annealing jig 20 includes a placement surface 20a, on which the stator core 10 is placed. The placement surface 20a is larger than a lower surface of the stator core 10, which is one end face in the stacking direction.

The placement surface 20a includes a planar portion 21 and multiple minute protrusions 22 protruding from the planar portion 21. The protrusions 22 support the lower surface of the stator core 10 from below. The protrusions 22 are formed to be spaced apart from each other over the entire placement surface 20a. The protruding amounts of the protrusions 22 from the planar portion 21 are in a range of several micrometers and several millimeters. The protrusions 22 are formed, for example, by shot blasting or by transferring the shape of a die.

### Annealing Method

Next, a method of annealing the stator core 10 will be described.

The annealing method includes a placing step and an annealing step.

As shown in FIG. 3, in the placing step, the stator core 10 is placed on the placement surface 20a of the annealing jig 20. At this time, the stator core 10 and the annealing jig 20 are in contact with each other only at the multiple protrusions 22. Accordingly, a gap G, into which an atmosphere gas enters, is formed by the planar portion 21, the protrusions 22, and the lower surface of the stator core 10.

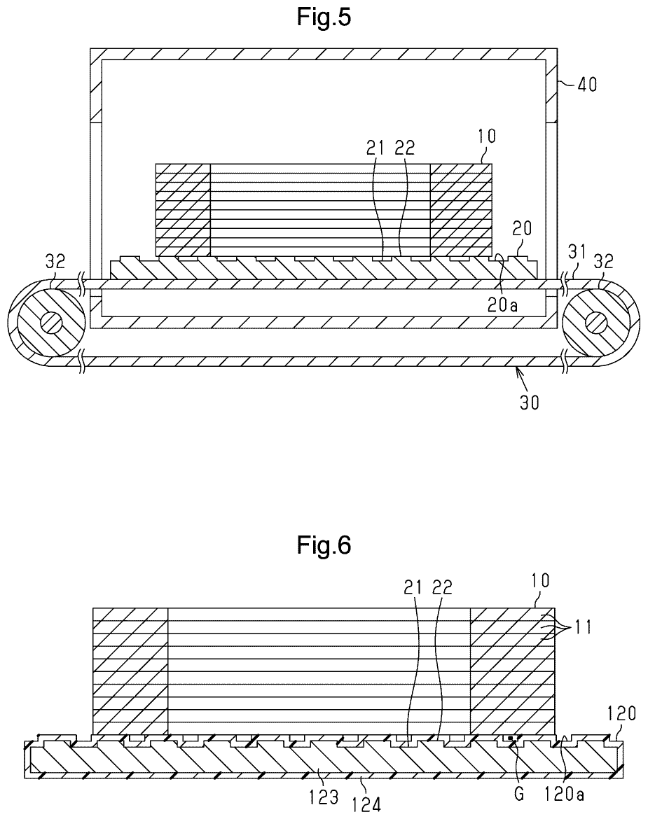

As shown in FIG. 5, in the annealing step, the annealing jig 20, on which the stator core 10 is placed, is conveyed into the annealing furnace 40 by a conveyor 30.

The conveyor 30 is, for example, a belt conveyor including an endless belt 31 and pulleys 32, which drive the belt 31.

Next, the annealing furnace 40 filled with an atmosphere gas is heated to anneal the stator core 10. The atmosphere gas is, for example, nitrogen gas.

When the stator core 10 is annealed, an oxide film is formed on the surface of the stator core 10 by a chemical reaction with the atmosphere gas. The oxide film improves corrosion resistance and rust resistance of the stator core 10.

### Operation and Advantages of the Present Embodiment

(1-1) The method of annealing the stator core 10 includes the placing step and the annealing step. In the placing step, the stator core 10 is placed on the placement surface 20a of the annealing jig 20, which is formed of a material having a coefficient of linear expansion different from that of the material of the stator core 10. In the annealing step, the stator core 10 placed on the placement surface 20a is annealed. The placement surface 20a includes the protrusions 22, which support the stator core 10 from below and are spaced apart from each other.

According to the above-described configuration, during annealing of the stator core 10, the stator core 10 is supported from below by the protrusions 22 of the annealing jig 20. As a result, compared to a case in which the entire lower surface of the stator core 10 is in contact with the annealing jig 20, the contact area between the stator core 10 and the annealing jig 20 is reduced. This mitigates the shearing force acting on the stator core 10 when the stator core 10 and the annealing jig 20 move relative to each other due to the differences in their respective coefficients of linear expansion during annealing. This configuration limits reduction in the dimensional accuracy of the stator core 10.

Also, when the stator core 10 is annealed, an oxide film is formed on the surface of the stator core 10 by a chemical reaction with the atmosphere gas. To improve the corrosion resistance and rust resistance of the stator core 10, it is desirable for the oxide film to be uniformly formed over the entire surface of the stator core 10. However, if the entire lower surface of the stator core 10 is in contact with the annealing jig 20, the atmosphere gas has difficulty reaching the lower surface of the stator core 10. As a result, the formation of the oxide film on the lower surface of the stator core 10 is hindered.

In this regard, according to the above-described configuration, since the protrusions 22 are spaced apart from each other, the gap G is formed between the lower surface of the stator core 10 and sections between the protrusions 22. When the atmosphere gas enters the gap G, the atmosphere gas easily reaches the lower surface of the stator core 10. Therefore, an oxide film is readily formed on the lower surface of the stator core 10.

(1-2) The stator core 10 is formed by stacking multiple thin plate-shaped iron core pieces 11.

Each of the iron core pieces 11, which form the stator core 10, has the shape of a thin plate shape and thus has a low stiffness. Consequently, if a shearing force acts on the stator core 10 due to relative movement between the stator core 10 and the annealing jig 20 during annealing, the iron core pieces 11 are prone to deformation. As a result, the dimensional accuracy of the stator core 10 is likely to decrease.

In this regard, according to the above-described configuration, the contact area between the stator core 10 and the annealing jig 20 is reduced by the protrusions 22. This reduces the shearing force acting on the iron core pieces 11. Therefore, it is possible to limit reduction in the dimensional accuracy of the stator core 10.

### Second Embodiment

The following describes a second embodiment, focusing on differences from the first embodiment. Identical components to those in the first embodiment are denoted by the same reference numerals, and redundant explanations are omitted.

In the second embodiment, the configuration of an annealing jig 120 is different from that of the annealing jig 20 of the first embodiment.

As shown in FIG. 6, the annealing jig 120 includes a base 123 having a planar portion 21 and multiple protrusions 22, and a coating film 124 covering the surfaces of the multiple protrusions 22.

The base 123 has the same configuration as the annealing jig 20 of the first embodiment. That is, the base 123 is formed of a material having a coefficient of linear expansion different from that of the material of the stator core 10.

The coating film 124 covers the entire surface of the base 123. The surface of the coating film 124 forms a placement surface 120a of the annealing jig 120. A gap G is formed between the protrusions 22 on which the coating film 124 is formed. The coefficient of friction between the coating film 124 and the stator core 10 is smaller than the coefficient of friction between the base 123 and the stator core 10. The coating film 124 preferably has heat resistance. The coating film 124 is, for example, chromium plating.

The annealing method of the present embodiment is the same as the annealing method of the first embodiment. That is, in the annealing step, the stator core 10 placed on the placement surface 120a, formed by the coating film 124, is annealed.

### Operation and Advantages of the Present Embodiment

In addition to the operation and the advantages (1-1) and (1-2) of the first embodiment, the second embodiment has the operation and the advantage described below.

(2-1) The annealing jig 120 includes the base 123, which has the protrusions 22, and the coating film 124, which covers the surfaces of the protrusions 22 and forms the placement surface 120a. The coefficient of friction between the coating film 124 and the stator core 10 is smaller than the coefficient of friction between the base 123 and the stator core 10.

According to the above-described configuration, since the coating film 124 is formed on the surfaces of the protrusions 22, the frictional force generated between the annealing jig 120 and the stator core 10 is reduced compared to a case in which the coating film 124 is not present. This mitigates the shearing force acting on the stator core 10 when the stator core 10 and the annealing jig 120 move relative to each other due to the differences in their respective coefficients of linear expansion during annealing. This configuration limits reduction in the dimensional accuracy of the stator core 10.

### Third Embodiment

The following describes a third embodiment, focusing on differences from the first embodiment. Identical components to those in the first embodiment are denoted by the same reference numerals, and redundant explanations are omitted.

In the third embodiment, the configuration of an annealing jig 220 is different from that of the annealing jig 20 of the first embodiment.

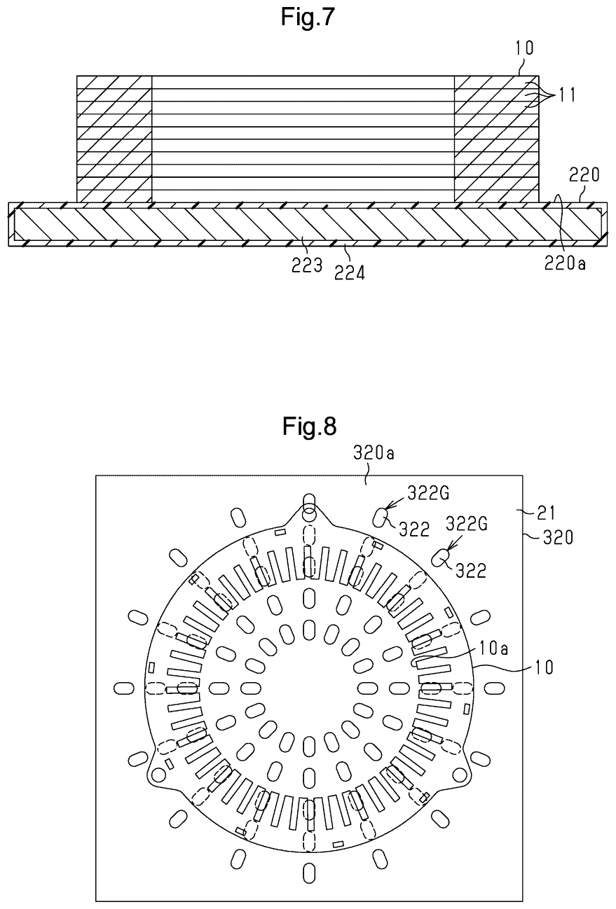

As shown in FIG. 7, the annealing jig 220 includes a flat-plate shaped base 223 and a coating film 224, which covers the surface of the base 223.

The base 223 is obtained by omitting the protrusions 22 from the annealing jig 20 of the first embodiment. That is, the base 223 is formed of a material having a coefficient of linear expansion different from that of the material of the stator core 10.

The coating film 224 covers the entire surface of the base 223. The surface of the coating film 224 forms a placement surface 220a of the annealing jig 220. The coefficient of friction between the coating film 224 and the stator core 10 is smaller than the coefficient of friction between the base 223 and the stator core 10. The coating film 224 preferably has heat resistance. The coating film 224 is, for example, chromium plating.

The annealing method of the present embodiment is the same as the annealing method of the first embodiment. That is, in the annealing step, the stator core 10 placed on the placement surface 220a, formed by the coating film 224, is annealed.

### Operation and Advantages of the Present Embodiment

In addition to the operation and the advantage (1-2) of the first embodiment, the third embodiment has the operation and the advantage described below.

(3-1) The annealing jig 220 includes the base 223 and the coating film 224, which covers the surface of the base 223 and forms the placement surface 220a. The coefficient of friction between the coating film 224 and the stator core 10 is smaller than the coefficient of friction between the base 223 and the stator core 10.

According to the above-described configuration, since the coating film 224 is formed on the surfaces of the base 223, the frictional force generated between the annealing jig 220 and the stator core 10 is reduced compared to a case in which the coating film 224 is not present. This mitigates the shearing force acting on the stator core 10 when the stator core 10 and the annealing jig 220 move relative to each other due to the differences in their respective coefficients of linear expansion during annealing. This configuration limits reduction in the dimensional accuracy of the stator core 10.

### Fourth Embodiment

The following describes a fourth embodiment, focusing on differences from the first embodiment. Identical components to those in the first embodiment are denoted by the same reference numerals, and redundant explanations are omitted.

In the fourth embodiment, the configuration of an annealing jig 320 is different from that of the annealing jig 20 of the first embodiment.

As shown in FIG. 8, a placement surface 320a of the annealing jig 320 includes a planar portion 21 and multiple minute protrusions 322 protruding from the planar portion 21. The protrusions 322 extend radially from a central portion of the placement surface 320a. Specifically, on the placement surface 320a, multiple protrusion groups 322G are arranged radially around the central portion in a planar direction of the placement surface 320a. Each protrusion group 322G includes multiple protrusions 322 arranged on the same line at intervals. Each of the protrusions 322 has the shape of a stadium elongated in the radial direction with the central portion of the placement surface 320a as the center. The protrusions 322 are formed, for example, by transferring the shape of a die.

In the placing step of the present embodiment, the stator core 10 is placed on the placement surface 320a such that the central portion of the placement surface 320a is surrounded by the outer edge of the lower surface, which is the contact surface of the stator core 10 in contact with the placement surface 320a. Specifically, the stator core 10 is placed on the placement surface 320a such that the central portion of the placement surface 320a is surrounded by the center hole 10a of the stator core 10. The annealing step of the present embodiment is the same as the annealing step of the first embodiment.

Operation and Advantages of the Present Embodiment

In addition to the operation and the advantages (1-1) and (1-2) of the first embodiment, the fourth embodiment has the operation and the advantage described below.

(4-1) The protrusions 322 extend radially from a central portion of the placement surface 320a. In the placing step, the stator core 10 is placed on the placement surface 320a such that the central portion of the placement surface 320a is surrounded by the outer edge of the lower surface of the stator core 10, which is in contact with the placement surface 320a.

According to the above-described configuration, the radial direction of the stator core 10 and the direction in which each protrusion 322 extends are likely to agree with each other. Accordingly, when the stator core 10 thermally expands and contracts in the radial direction before and after the stator core 10 is annealed, the protrusions 322 move in the radial direction in accordance with the thermal expansion and the thermal contraction of the placement surface 320a. Thus, compared to a case in which the protrusions 322 extend in a direction orthogonal to the radial direction, this configuration suppresses an increase in the contact area in which the protrusions 322 slide against the lower surface of the stator core 10. Consequently, the shearing force acting on the stator core 10 is reduced.

### Modifications

The above-described embodiments may be modified as follows. The above-described embodiments and the following modifications can be combined as long as the combined modifications remain technically consistent with each other.

In the second embodiment, the coating film 124 may cover only the surfaces of the protrusions 22.

In the second embodiment and the third embodiment, the coating films 124, 224 may be plating of a type different from chromium plating. The coating films 124, 224 may be formed by, for example, physical vapor deposition (PVD) or chemical vapor deposition (CVD).

In the second embodiment and the third embodiment, when an insulating film is formed on the surface of the iron core piece 11, the coefficient of friction between the coating film 124, 224 of the annealing jig 120, 220 and the insulating film is preferably smaller than the coefficient of friction between the base 123, 223 and the insulating film.

The coating film 124 of the second embodiment can also be employed in the fourth embodiment. In other words, the annealing jig 320 may include the coating film 124, which covers the surfaces of the protrusions 322.

In each embodiment, the core blocks of the stator core 10 do not necessarily need to be joined through welding. The core blocks may be joined by interlocking the tabs 16a together or may be joined via a resin material.

The method for annealing an iron core and the annealing jig can be embodied as various iron core annealing methods using the principle of electromagnetic induction and annealing jigs used in such methods. Such iron cores include a rotor core of a rotating electric machine or an iron core of a transformer. In addition, the iron cores are not limited to an iron core formed by stacking multiple thin plate-shaped iron core pieces, and may be formed of a single magnetic material.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method of annealing an iron core, comprising:
placing the iron core on a placement surface of an annealing jig formed of a material having a coefficient of linear expansion different from that of a material of the iron core; and
annealing the iron core placed on the placement surface,
wherein multiple protrusions that support the iron core from below and are spaced apart from each other are formed on the placement surface.

2. The method of annealing the iron core according to claim 1, wherein
the annealing jig includes:
a base that includes the protrusions; and
a coating film that covers surfaces of the protrusions and forms the placement surface, and
a coefficient of friction between the coating film and the iron core is smaller than a coefficient of friction between the base and the iron core.

3. The method of annealing the iron core according to claim 1, wherein
the protrusions extend radially from a central portion of the placement surface, and
the placing the iron core on the placement surface of the annealing jig includes placing the iron core on the placement surface such that the central portion of the placement surface is surrounded by an outer edge of a contact surface of the iron core that is in contact with the placement surface.

4. The method of annealing the iron core according to claim 1, wherein the iron core is a laminated iron core formed by stacking multiple thin plate-shaped iron core pieces.

5. A method of annealing an iron core, comprising:
placing the iron core on a placement surface of an annealing jig formed of a material having a coefficient of linear expansion different from that of a material of the iron core; and
annealing the iron core placed on the placement surface, wherein
the annealing jig includes:
a base; and
a coating film that covers a surface of the base and forms the placement surface, and
a coefficient of friction between the coating film and the iron core is smaller than a coefficient of friction between the base and the iron core.

6. The method of annealing the iron core according to claim 5, wherein the iron core is a laminated iron core formed by stacking multiple thin plate-shaped iron core pieces.
